(19) United States
(12) Patent Application Publication
(10) Pub. No.: US 2004/0063440 A1
(43) Pub. Date: Apr. 1, 2004

(54) Method for co-ordinating the transmission interruptions in a plurality of base stations in a cellular radio communication system, and corresponding radio communication system

(76) Inventors: Mark Beckmann, Braunschweig (DE); Siegfried Bar, Unterschleissheim (DE); Thomas Gottschalk, Berlin (DE); Martin Hans, Hildesheim (DE); Josef Laumen, Hildesheim (DE)

Correspondence Address: BELL, BOYD & LLOYD, LLC, P. O. BOX 1135, CHICAGO, IL, 60690-1135, US

(21) Appl. No.: 10/466,227

(22) PCT Filed: Dec. 12, 2001
(86) PCT No.: PCT/DE01/04669

(30) Foreign Application Priority Data
Jan. 12, 2001 (DE) 101 01 503.8

(51) Int. Cl. H04M 1/00; H04B 1/38

(52) U.S. Cl. 455/456.1; 455/404.2; 455/422.1; 455/560

(57) ABSTRACT

The invention relates to the co-ordination of transmission interruptions in the radio traffic of a plurality of base stations (BS1 with BS10) in a cellular radio communication system (FN1) having a plurality of subscriber devices (MP1). To this end, at least one information signal (ARR12, RRR21) is transmitted between at least one first control unit (RNC1) associated with the base station (BS3) of the location radio cell (FZ3) of the corresponding subscriber device (MP1) to be localised, and at least one second control unit (RNC2) associated with the base station (BS8) of at least one adjacent radio cell (FZ8), over the temporal position of the transmission interruptions in the base station (BS3) of the location radio cell (FZ3) and/or the base station (BS8) of at least one adjacent radio cell (FZ8).

The object of the invention is to improve the chances of a mobile radio device to be localized or a mobile radio station being able to “hear” location measurement signals from adjacent base stations and take delay time measurements.

This object is achieved by the following inventive method:

Method for coordinating the transmission interruptions of location measurement signals from a plurality of base stations in a cellular radio communication system, with the transmission interruptions of the plurality of base stations being carried out during transmission by these latter location measurement signals to determine the position of at least one mobile radio station to be localized, with the radio traffic in the radio cells of the base station being controlled using radio network controllers, with at least one information signal relating to the temporal position of the transmission interruptions of the location measurement signals of the base station of the location radio cell and/or the base station of at least one adjacent radio cell being transmitted between at least one first radio network controller, which is associated with the base station in the location radio cell of the mobile radio station to be localized in each instance and at least one second radio network controller, which is associated with the base station of at least one adjacent radio cell and with the temporal position of the transmission interruptions of the location measurement signals of the base station in the location radio cell and/or the base station in at least one adjacent radio cell being coordinated on the basis of said information signal, which is characterized in that at least one inquiry signal is sent as an information signal from the first radio network controller of the base station of the location radio cell to the respective second radio network controller of at least one of the adjacent base stations, with which the temporal position of the transmission interruptions of the location measurement signals of said adjacent base station is requested, or that at least one information signal giving notification of a previously selected temporal position of the transmission interruptions of the location measurement signals of the base station of the location radio cell is sent from the first radio network controller of the base station of the location radio cell to the respective second radio network controller of at least one of the adjacent base stations.

This allows the configuration or setting of the temporal position of the interruptions of location measurement signals of the base stations, even if the base stations are connected to different radio network controllers or RNCs.

These show:

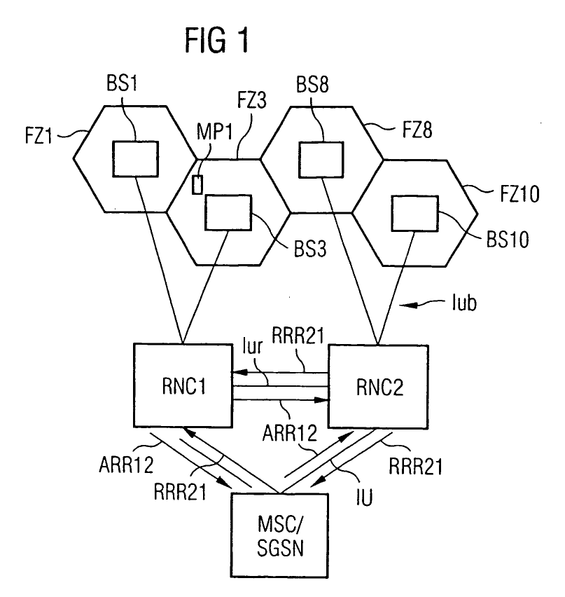

FIG. 1, 2 each shows an architecture with base stations in radio cells of a mobile radio system with associated radio network controllers to control them and with higher-level network units to implement the inventive method and

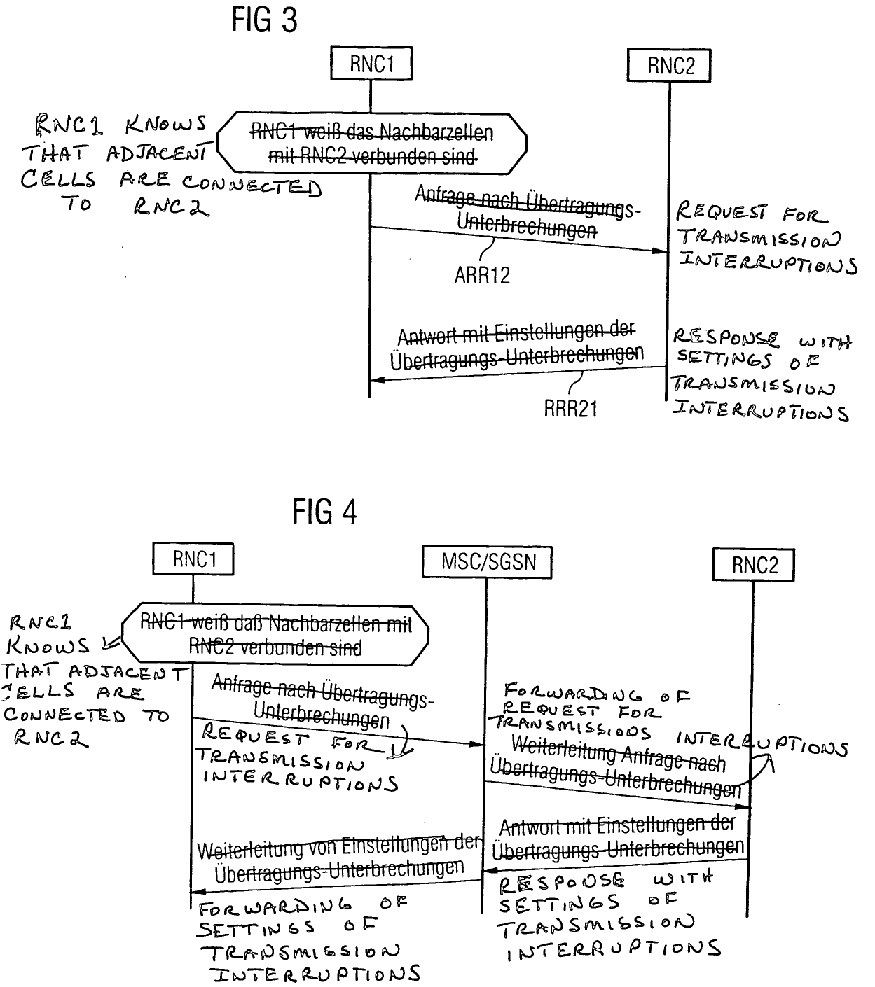

FIGS. 3 to 8 different options for the configuration of transmission interruptions according to the inventive method.

In a cellular mobile radio system, base stations each cover one cell. Within a cell a mobile radio station can have a radio connection with the base station covering this cell. One or a plurality of base stations BS1 to BS10 are connected via fixed network connections to what is known as a radio network controller or RNC. These fixed network connections are referred to in UMTS as Iub. The radio network controllers (RNC) are responsible for example for controlling radio resources. One or a plurality of radio network controllers are each connected via further fixed network connections to a higher-level network unit MSC (Mobile Switching Center) and SGSN (Serving GPRS Support Node). These fixed network connections are referred to in the UMTS standard as Iu. MSC and SGSN are responsible for control tasks relating to the mobile radio stations. They ensure for example that incoming calls from external networks are ultimately forwarded to the base station, which has a radio connection to the required mobile radio station. The fixed network controllers are also interconnected to a fixed network connection. These fixed network connections are referred to in UMTS as Iur and are for example necessary to forward control information stored in an RNC for a specific mobile radio station to another RNC. This is for example necessary when a mobile radio station moves from one cell, which is covered by a first base station, which in turn is connected to a first (Source RNC) RNC RNC1, to a different cell, which is covered by a second base station, which is connected to a second (Target RNC) RNC RNC2. The architecture described is shown in FIG. 1. The higher-level network unit is referred to here as MSC/SGSN. These units are separated in reality and each of these units MSC and SGSN has its own Iu connection to the RNCs.

What is known as the OTDOA method (OTDOA=Observed Time Difference Of Arrival) is disclosed in the technical specification TS 25.305 “Stage 2 functional specification of location services in UTRAN”. This method is based on a mobile radio station measuring the time differences required by signals from two different base stations to reach the mobile radio station. These time differences can also be referred to as delay time differences. In a cellular mobile radio system each base station covers one cell. The base station covering the cell in which the mobile radio station is localized is then used as the reference base station. The position of the mobile radio station can be determined by 3 measurements of delay time differences between the reference base station and 3 different, adjacent base stations.

This position determination method can encounter problems when a mobile radio station cannot hear the adjacent cells. In other words, the mobile radio station cannot receive signals from the adjacent base stations and therefore cannot measure delay time differences. To resolve this problem or improve the chance of a mobile station being able to “hear” adjacent base stations, what are known as IPDLs (Idle Periods DownLink) were introduced. With these the base station of the cell in which the mobile radio station is localized interrupts all transmissions for a short period, thereby increasing the chance that the mobile radio station can carry out delay time measurements of signals from the adjacent base stations.

Not in the standard at present but conceivable for future versions is what is known as a “Time aligned IPDL” method. This method is for example disclosed in more detail in the document “Time Aligned FP-PL positioning technique” TSGR1#(99)679 TSG-RAN Working Group 1, HU Hoc 17, Meeting 7, Hanover, Germany, August 30- Sep. 3 1999. With this method not only is transmission from the reference base station interrupted for a short period but also transmissions from all adjacent base stations apart from transmission from one adjacent base station, for which the delay time difference is to be established. The transmission interruptions of all adjacent base stations must then be configured so that only one adjacent base station transmits during this interruption and the transmitting base station is always different from the transmitting base station during the previous transmission interruption.

The adjacent base stations can also use transmission interruptions. Interruptions to transmission must be set for the IPDL method in such a way that interruptions for two adjacent base stations do not take place at the same time, as the mobile radio station can then not hear the adjacent base station. For the Time aligned IPDL method the interruptions to transmissions must be set so that only one adjacent base station transmits during the interruption. If the adjacent base stations are all connected to the same RNC, this RNC can configure the transmission interruptions of the individual base stations so that adjacent base stations never interrupt transmission at the same time for the IPDL method or so that only one adjacent base station transmits for the Time aligned IPDL method. However it can happen that a mobile radio station MP1 is localized in a cell FZ3 (see FIG. 1), which is covered by a first base station BS3, which is connected to a first RNC RNC1 and its adjacent cell FZ8 is covered by a second base station BS8, which is connected to a second RNC RNC2.

The present invention allows the configuration of base stations so that base stations, which cover adjacent cells, never interrupt transmission at the same time, when the IPDL method is used or so that only one adjacent base station transmits, when the Time aligned IPDL method is used, even if the base stations are connected to different RNCs. Only the configuration for the IPDL method is described below. The described methods can however also be used for the Time aligned IPDL method.

The configuration can be based on two possible methods according to this invention.

In the first method arrangements are to be settled via the MSC/SGSN network units. This is advantageous as one MSC/SGSN can be connected to a plurality of RNCs and therefore all the base stations of all the RNCs connected to this MSC/SGSN can be configured appropriately. As a result the MSC/SGSN network units only have to exchange information about the transmission interruptions from adjacent base stations, which are also connected via different RNCs to different MSCs/SGSNs. To allow this, it must be known in the MSC/SGSN which cells are adjacent and are covered by base stations, which are connected via different RCNs to different MSCs/SGSNs. Also the MSCs/SGSNs are notified of the configuration of the transmission interruptions of the cells, which are adjacent to cells connected to other MSCs/SGSNs. For this purpose the MSC/SGSN requests the configuration of these “boundary cells” from the RNCs, with which the cells are associated. As according to this method an RNC does not know to which adjacent RNC the adjacent cells belong, an RNC, to which a cell belongs, for which transmission interruptions are to be configured, interrogates the higher-level network unit MSC/SGSN, if the adjacent cells do not belong to this RNC. MSC/SGSN then verifies whether the cells are all connected to it and interrogates the corresponding MSC/SGSN, if this is not the case. This method is of less relevance for UMTS; only one embodiment is therefore specified to describe the case in which adjacent cells are connected via two different RNCs to two different higher-level network units MSCs/SGSNs. This method is advantageous, if it is not known in a first RNC to which other RNC the adjacent cells are connected, which are not connected to the first RNC but information about which RNCs belong to the adjacent cells is only known in higher-level network units such as MSC/SGSN.

In the second method arrangements are to be settled via the RNCs. This is particularly advantageous, as the complexity is broken down into smaller areas. Here the RNCs can only exchange information about the transmission interruption of adjacent cells between them. This is particularly advantageous, if, in the case of UMTS, the RNCs know which cells are adjacent and which of the cells belong to a different RNC. It is quite particularly advantageous for the configuration of the transmission interruption not to have to be sent to the MSCs, as these configurations exist in the RNC.

It is particularly advantageous for the information only to have to be exchanged, when a mobile radio station has to determine the delay time differences of base stations which are connected to different RNCs. This also makes it possible to stop and start transmission interruptions in one cell at any time.

Before starting transmission interruptions in a first cell, the first RNC, to which this first cell is associated, in the event that the first cell is adjacent to a second cell, which is associated with a second RNC, requests the configuration of the transmission interruptions of the second cell from the second RNC. The first RNC can then configure the first cell so that the transmission interruptions in the cell do not overlap with the transmission interruptions of the second cell.

1^{st} Exemplary Embodiment

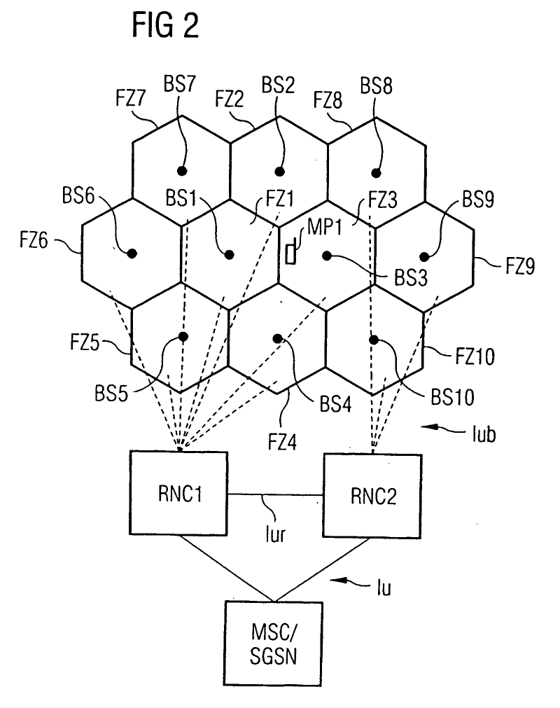

In the first embodiment it is assumed that the base stations BS1 to BS10 cover the cells FZ1 to FZ10 and the base stations BS1 to BS7 are connected to the radio network controller RNC1 and the base stations BSB, BS9 and BS10 are connected to the radio network controller RNC2 (see FIG. 2). Arrangements are also to be settled via the RNCs.

It is also assumed that a mobile station MP1 is localized in the cell FZ3. The position of the mobile station MP1 is to be determined and it is irrelevant here whether the inquiry to determine position originates from the mobile station or from the network. It is also assumed that the position is to be determined using the OTDOA method. In this the mobile radio station determines the delay time differences between signals from adjacent base stations and signals from the base station in which the mobile radio station is localized, i.e. in this case the base station BS3. The base station BS3 is also to interrupt transmission for the measurement period (IPDL, Idle Periods Downlink) so that the mobile radio station MP1 has a better chance of receiving adjacent base stations. It is assumed that no transmission interruption has been configured at present for the base station BS3. It is also assumed that the adjacent cell FZ9, which is connected to the RNC RNC2, also uses such transmission interruptions, to allow other mobile radio stations in the cell FZ9 to receive adjacent cells. It should also be known in the RNC RNC1 that the cell FZ3 is adjacent to the cells FZ1, FZ2, FZ4, FZ8, FZ9 and FZ10 and that the cells FZ8, FZ9 and FZ10 are connected to the RNC RNC2.

The embodiment can be subdivided further:

a) There is an (Iur) connection between the RNC RNC1 and the RNC RNC2

b) There is no (Iur) connection between the RNC RNC1 and the RNC RNC2

a) There is an Iur Connection Between the RNC RNC1 and the RNC RNC2 (see also FIG. 1):

If there is an Iur connection between the RNC RNC1 and the RNC RNC2, the RNC RNC1 sends a message ARR12 to the RNC RNC2 with the request to send the configuration of the transmission interruptions for the cells FZ8, FZ9 and FZ10 to the RNC RNC1. It is assumed for the cells FZ8 and FZ10 that no transmission interruptions have been configured for them. Transmission interruptions have however already been configured for cell FZ9. According to the invention therefore the RNC RNC2 sends a response RRR21 to the RNC RNC1 containing the configuration of the transmission interruptions for cell FZ9 and notifying the RNC RNC1 that no transmission interruptions are configured for cells FZ8 and FZ10. The RNC RNC1 then configures the transmission interruptions for cell FZ3 so that the transmission interruptions never occur at the same time in cell FZ3 and cell FZ9.

The sequence of this process is shown in FIG. 3. The vertical lines here designate a network unit. The nature of the network unit is specified in the box at the top of the vertical line. The arrows between the vertical lines represent the messages, which are exchanged between the RNC RNC1 and the RNC RNC2.

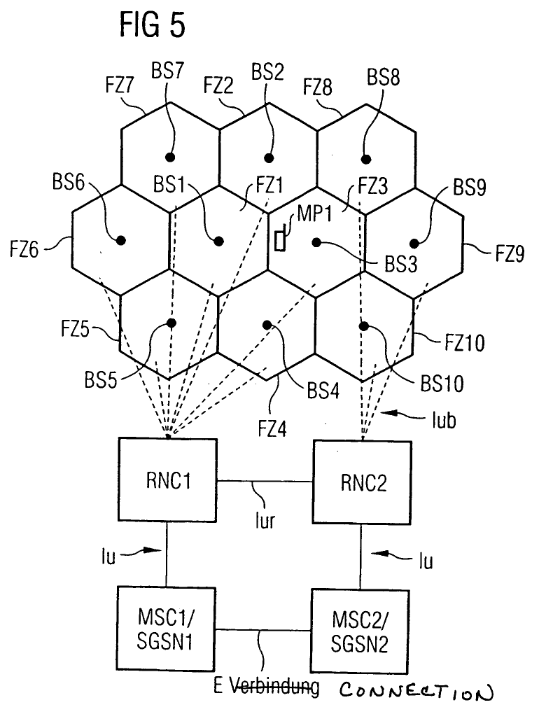

b) There is no Iur Connection Between the RNC RNC1 and the RNC RNC2 (see FIGS. 1 and 4):

If there is no Iur connection between the RNC RNC1 and the RNC RNC2, the RNC RNC1 sends a message ARR12 via the Iu connection to the higher-order network unit, either MSC or SGSN. The RNC RNC1 uses this message to request the transmission interruption configuration of cells FZ8 to FZ10 from the higher-level network unit. The higher-level network unit then forwards this request via a further Iu connection to the RNC RNC2. This latter sends a response ARR21 with the configuration of the cell FZ9 and the information that no transmission interruptions have been configured for the cells FZ8 and FZ10 back to the higher-level network unit, which the higher-level network unit forwards to the RNC RNC1. The RNC RNC1 therefore knows the configuration of the transmission interruption of the cells FZ8 to FZ9 and configures the transmission interruption of the cell FZ3 so that the transmission interruptions of the cells FZ3 and FZ9 never take place at the same time.

The sequence of this process is shown in FIG. 4.

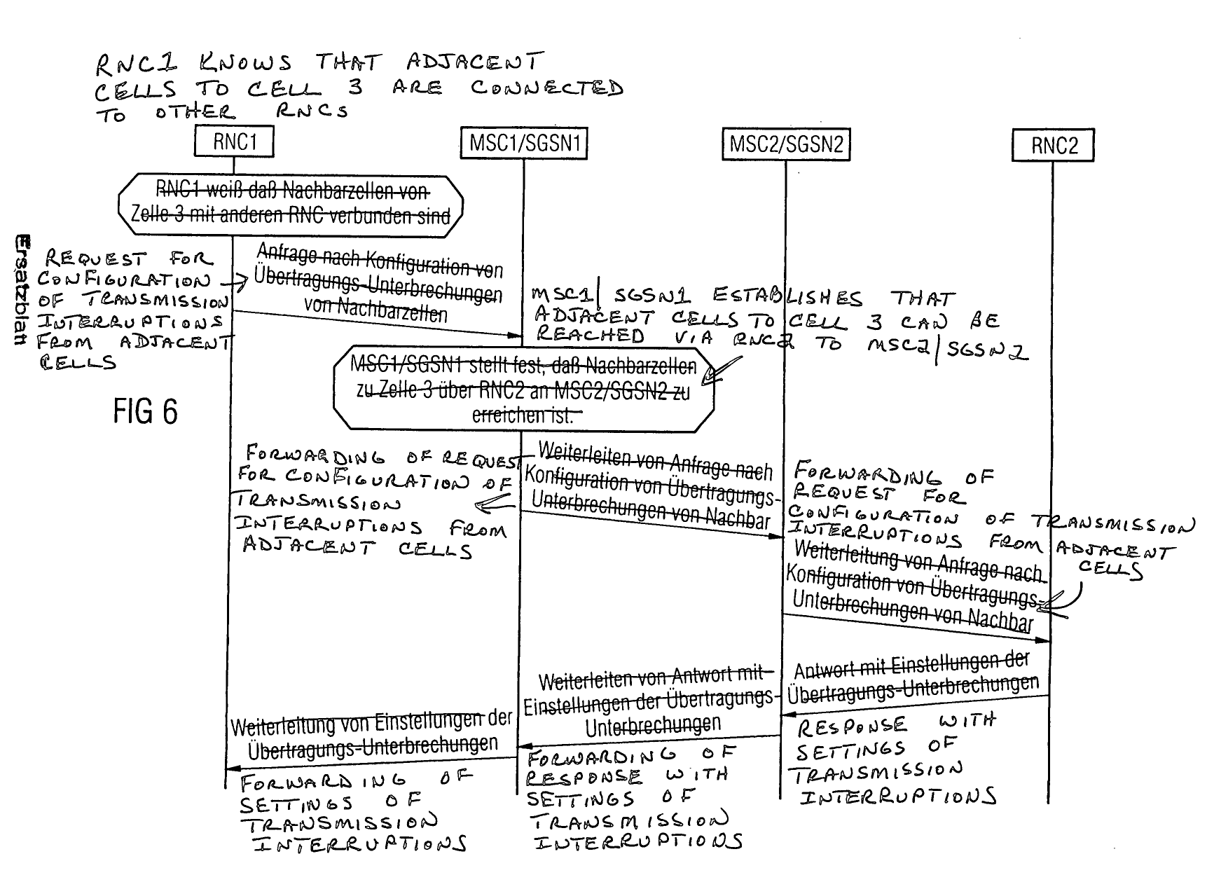

It is also conceivable for the RNC RNC1 and the RNC RNC2 to be connected to two different MSCs/SGSNs. FIG. 5 shows such an architecture. Here the RNC RNC1 is connected to the MSC/SGSN MSC1/SGSN1 and the RNC RCN2 to the MSC/SGSN MSC2/SGSN2. The request from the RNC RNC1 for the configurations of the cells FZ8 to FZ10 is then forwarded from the MSC/SGSN MSC1/SGSN1 to the MSC/SGSN MSC2/SGSN2, which then forwards the request to the RNC RNC2. The RNC RNC2 sends the response, which contains the configuration settings of the cells FZ8 to FZ10, back via the connection “E connection” to the MSC/SGSN MSC2/SGSN2, which forwards the response to the MSC/SGSN MSC1/SGSN1. This latter then forwards the response to the RNC RNC1. FIG. 6 shows the sequence of this process.

2^{nd} Exemplary Embodiment

In the second embodiment it is assumed that the base stations BS1 to BS10 cover the cells FZ1 to FZ10 and the base stations BS1 to BS7 are connected to the radio network controller (=RNC) RNC1 and the base stations BS8, BS9 and BS10 are connected to the radio network controller (=RNC) RNC2 (see FIG. 2). The RNC RNC1 is also to be connected to the higher-level network unit MSC/SGSN MSC1/SGSN1 and the RNC RNC2 is also to be connected to the higher-level network unit MSC2/SGSN2. The structure is shown in FIG. 5. Arrangements are to be settled here between the higher-level network units MSC/SGSN. It is now in turn assumed that a mobile radio station MP1 is localized in cell FZ3 and its position is to be determined using the OTDOA method. Also the chance of the mobile radio station receiving adjacent cells is to be increased by means of transmission interruptions from base station BS3. It is also assumed that transmission interruptions have already been configured for the cell FZ9. It should also be known in the MSCs/SGSNs which cells, which are associated with the respective MSCs/SGSNs, are adjacent to cells, which are associated with other MSCs/SGSNs.

The RNC1 now notifies the MSC/SGSN MSC1/SGSN1 via the Iu connection that it can insert transmission interruptions in the cell FZ3. The MSC/SGSN MSCl/SGSN1 identifies that the cell FZ3 is adjacent to cells, which are associated with the MSC/SGSN MSC2/SGSN2. The MSC/SGSN MSC1/SGSN1 then sends a message to the MSC/SGSN MSC2/SGSN2, in which the configuration of transmission interruptions of the cells FZ8 to FZ10 is requested.

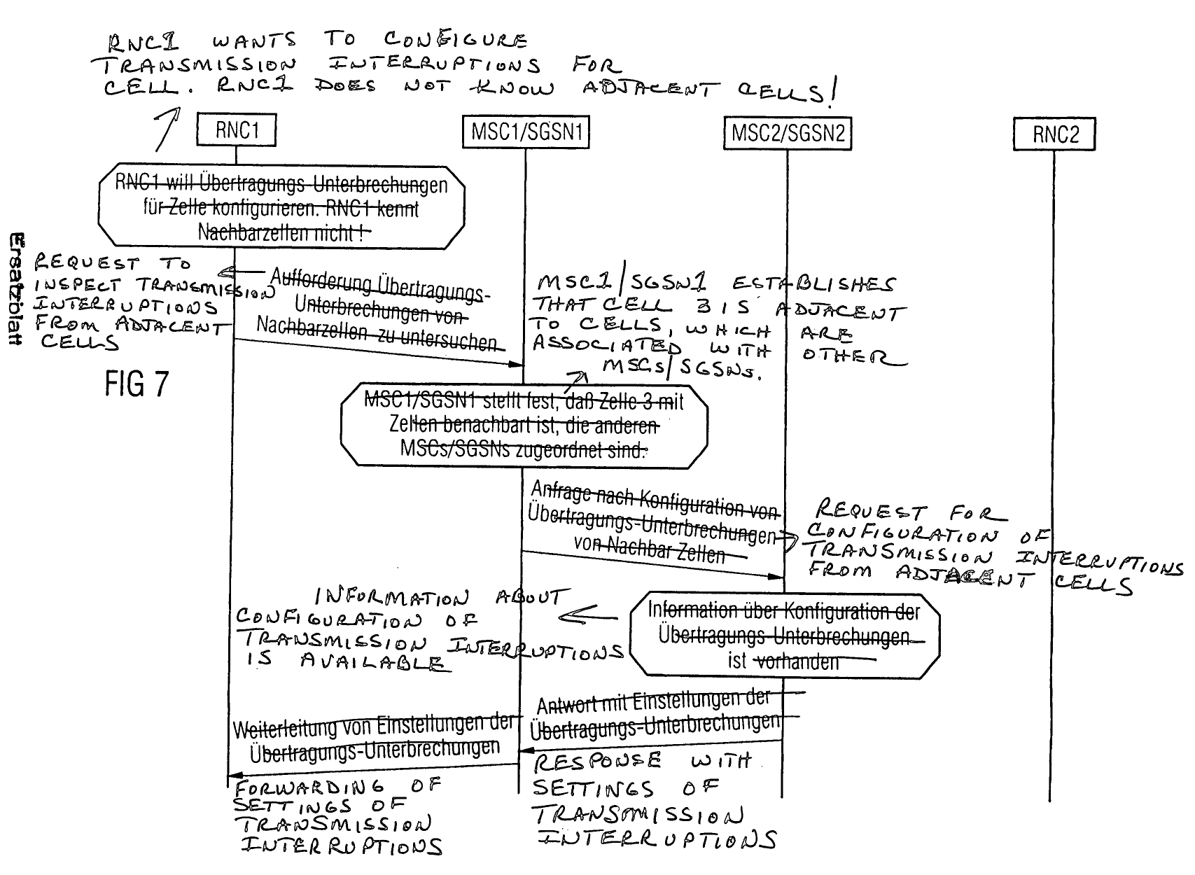

If the MSC/SGSN MSC2/SGSN2 knows the configuration of the cells FZ8 to FZ10, it sends a response back to the MSC/SGSN MSCl/SGSN1, containing the configuration of the transmission interruption of the cell FZ9 and from which it can be identified that no transmission interruptions are configured in the cells FZ8 and FZ10. The sequence of this process, in which the MSC/SGSN MSC2/SGSN2 already knows the configuration of the cells FZ8 to FZ10, is shown in FIG. 7.

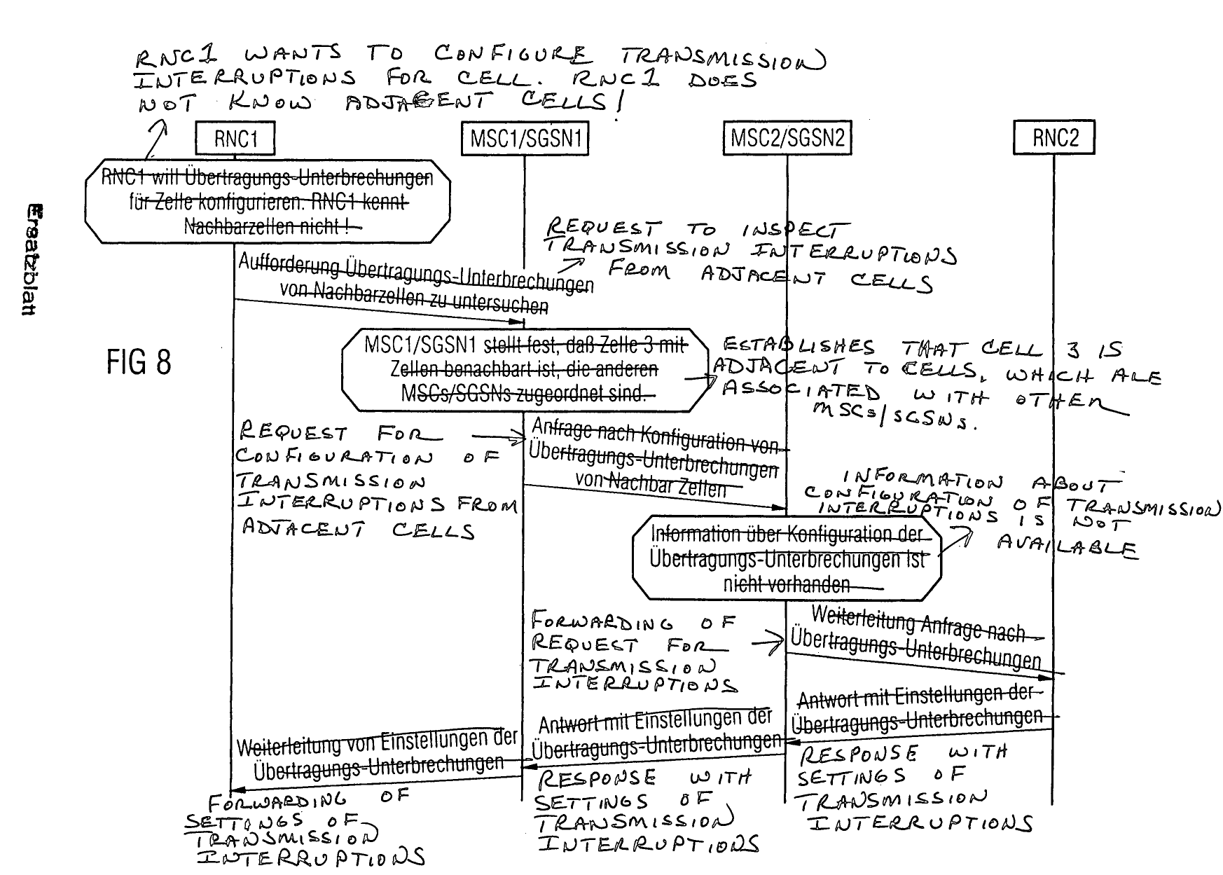

If the MSC/SGSN MSC2/SGSN2 does not know the configuration of the cells FZ8 to FZ10, the MSC/SGSN MSC2/SGSN2 sends a request to the RNC RNC2 to send back the configuration of the transmission interruptions of the cells FZ8 to FZ10. The RNC RNC2 then sends the configuration back to the MSC/SGSN MSC2/SGSN2, which in turn sends a message to the MSC/SGSN MSC1/SGSN1, from which it can be seen that no transmission interruptions are configured for the cells and which contains the configuration of the cell FZ9. The sequence of this method is shown in FIG. 8.

The MSC/SGSN MSC1/SGSN1 then informs the RNC RNC1 of what the configuration of the transmission interruption for the cell FZ9 looks like, so that the RNC RNC1 can select the transmission interruption for the cell FZ3 so that the transmission interruptions never take place at the same time.

1. Method for coordinating the transmission interruptions of location measurement signals of a plurality of base stations (BS1 to BS10) in a cellular radio communication system (FN1), with the transmission interruptions of the plurality of base stations (BS1 to BS10) being carried out during their transmission of location measurement signals for determining the position of at least one mobile radio station (MP1) to be localized, with the radio traffic in the radio cells (FZ1 to FZ10) of the base stations (BS1 to BS10) being controlled using radio network controllers (RNC1, RNC2), with at least one information signal (ARR12, RRR21) relating to the temporal position of the transmission interruptions of location measurement signals of the base station (BS3) of the location radio cell (FZ3) and/or the base station (BS8) of at least one adjacent radio cell (FZ8) being transmitted between at least one first radio network controller (RNC1), which is associated with the base station (BS3) in the location radio cell (FZ3) of the mobile radio station (MP1) to be localized in each instance and at least one second radio network controller (RNC2), which is associated with the base station (BS8) of at least one adjacent radio cell (FZ8), with the temporal position of the transmission interruptions of the location measurement signal of the base station (BS3) in the location radio cell (FZ3) and/or of the base station (BS8) of at least one adjacent radio cell (FZ8) being coordinated on the basis of said information signal (ARR12, RRR21,
characterized in that
at least one inquiry signal (ARR12) is sent as the information signal from the first radio network controller (RNC1) of the base station (BS3) of the location radio cell (FZ3) to the respective second radio network controller (RNC2) of at least one of the adjacent base stations (BS8), with which the temporal position of the transmission interruptions of the location measurement signals of this respectively adjacent base station (BS8) is requested, or that at least one information signal (ARR12) giving notification of a previously selected temporal position of the transmission interruptions of the location measurement signals of the base station (BS3) of the location radio cell (FZ3) is sent from the first radio network controller (RNC1) of the base station (BS3) of the location radio cell (FZ3) to the respective second radio network controller (RNC2) of at least one of the adjacent base stations (BS8).

2. Method according to claim 1,
characterized in that
the transmission interruptions of the associated base stations (BS1 to BS7; BS8 to BS10) are coordinated in such a way by the first radio network controller (RNC1) and/or the second radio network controller (RNC2) that one or a plurality of location measurement signals are sent essentially simultaneously from one or a plurality of adjacent base stations (BS1, BS2, BS8 to BS10, BS5) to the base station (BS3) of the location radio cell (FZ3), while this latter interrupts transmissions for a predefinable time period.

3. Method according to claim 1,
characterized in that
the transmission interruptions of the associated base station (BS1 to BS10) are coordinated in such a way by the first radio network controller (RNC1) and/or the second radio network controller (RNC2) that one or a plurality of location measurement signals are sent only individually from one or a plurality of adjacent base stations (BS1, BS2, BS8 to BS10, BS5) in a predefinable time sequence to the base station (BS3) of the location radio cell (FZ3), while the base station there (BS3) interrupts transmission for a predefinable time period in each instance.

4. Method according to one of the preceding claims,
characterized in that
location measurement signals are sent from at least three adjacent base stations (BS1, BS8, BS9) to the base station (BS3) of the location radio cell (FZ3).

5. Method according to one of the preceding claims,
characterized in that
transmission of the at least one information signal (ARR12) is carried out in a GSM (Global System for Mobile Communication), UTMS (Universal Mobile Communication System), GPRS (General Packet Radio Service) and/or in the EDGE (Enhanced Data Rates for GSM) radio communication system, in particular a mobile radio system.

6. Radio communication system (FN1) with a plurality of base stations (BS1 to BS10) in associated radio cells (FZ1 to FZ10), with at least one first radio network controller (RNC1) being associated with at least one first group of base stations (BS1 to BS7) and at least one second radio network controller (RNC2) being associated with at least one second group of base stations (BS8 to BS9) and with means (RNC1, RNC2) for implementing the method according to one of the preceding claims.
